(19) United States
(12) Patent Application Publication
(10) Pub. No.: US 2008/0031597 A1
(43) Pub. Date: Feb. 7, 2008

(54) Stream Recording/Reproducing Apparatus

(76) Inventor: Etsuto Nakatsu, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/628,578

(22) PCT Filed: Jul. 11, 2005
(86) PCT No.: PCT/JP05/13199

§ 371 Date: Dec. 6, 2006

(30) Foreign Application Priority Data
Jul. 12, 2004 (JP) 2004-204367

(51) Int. Cl. H04N 7/26

(52) U.S. Cl. 386/124; 386/E05.001

(57) ABSTRACT

The present invention provides a stream recording/reproducing apparatus that records a stream onto a first recording medium without using extra recording capacity of such first recording medium, and then dubs such stream onto a second recording medium at high speed while minimizing the degradation in image quality and sound quality. The stream recording/reproducing apparatus of the present invention includes: an analysis unit (6) that judges whether or not a stream (101) is compliant with the logic specification of a second recording medium (7); a management information recording unit (8) that records a result of the judgment onto a first recording medium (3); a TS recording processing unit (2) that records the stream (101) onto the medium (3); processing units (14) and (15) that convert the stream (101) recorded on the medium (3) into a stream that is compliant with the logic specification of the medium (7) in the case where the stream (101) is not compliant with the logic specification of the medium (7); and a PS recording processing unit (17) that records the converted stream onto the medium (7).

### TECHNICAL FIELD

The present invention relates to a stream recording/reproducing apparatus that records a stream such as video onto a first recording medium, and then dubs such stream onto a second recording medium such as a removable medium.

### BACKGROUND ART

With the advances in the technology of encoding and compression, there is a proliferation of recording/reproducing apparatuses that compress a video signal and an audio signal, and record the compressed signals onto a recording medium. Such recording/reproducing apparatuses include DVD recorders that contain a hard disk drive (hereinafter referred to as “HDD”) with large recording capacity.

Typical use of a DVD recorder is as follows: a user previously records and accumulates, on the HDD, programs to be broadcast, using the timer recording function or the like, and in the case where such user views these programs later on and performs an operation to record them, such programs are dubbed onto a digital versatile disc (hereinafter referred to as “DVD”). Recently, DVD recorders with HDD and digital broadcasting tuner have been under development. Such an apparatus records a digital broadcast stream (transport stream) directly onto the HDD. In the case of dubbing the broadcast stream recorded on the HDD, such apparatus decodes the transport stream recorded on the HDD using a Moving Picture Expert Group (hereinafter referred to as “MPEG”) decoder, encodes the decoded transport stream again into a program stream supported by the DVD recording format, and then records the resulting encoded stream onto a DVD.

As described above, the above apparatus dubs the broadcast stream recorded on the HDD onto a DVD after decoding and encoding the recorded broadcast stream. This makes it impossible for such apparatus to perform dubbing at high speed. Furthermore, the qualities of video and sound (image quality and sound quality) constituting the program stream obtained by such apparatus is lower than the qualities of video and sound (image quality and sound quality) constituting the transport stream recorded on the HDD.

As a technology aiming at a higher dubbing speed and the prevention of the degradation in image quality and sound quality, there is disclosed a first technology described below (for example, refer to Japanese Laid-Open Patent application No. 2003-224822). According to the first technology, a stream is generated that has the same contents as that of a transport stream to be broadcast and that is in the format supported by a destination recording medium onto which the stream is to be dubbed (hereinafter referred to simply as “destination recording medium”), and such generated stream and the transport stream are recorded onto the HDD at the same time. At the time of dubbing, the stream in the format supported by the destination recording medium is simply copied onto the destination recording medium. The first technology achieves a faster dubbing speed and the prevention of the degradation in image quality and sound quality in the above manner.

There is also disclosed a second technology described below (for example, refer to Japanese Laid-Open Patent application No. 2003-32617). According to the second technology, in the case where analog audio and video signals such as analog broadcasting is encoded and compressed to be recorded onto an HDD, a stream for reproduction and viewing and a stream in the format supported by a destination recording medium are encoded and compressed to be recorded onto the HDD at the same time. At the time of dubbing, the stream in the format supported by the destination recording medium is simply copied onto the destination recording medium. The second technology achieves a faster dubbing speed and the prevention of the degradation in image quality and sound quality in the above manner.

### DISCLOSURE OF INVENTION

As described above, according to the above-described first technology and second technology, in the case where one program is to be recorded, two streams are recorded onto an HDD, a stream for reproduction and viewing and a stream in the format supported by a destination recording medium. Therefore, extra recording capacity of the HDD is used compared with the case where only one stream (stream for reproduction and viewing) is recorded onto the HDD. As a result, time for recording is reduced.

In view of the above problems, an object of the present invention is to provide a stream recording/reproducing apparatus that records a stream such as video onto a first recording medium without using extra recording capacity of such first recording medium, and then dubs the stream onto a second recording medium at high speed while minimizing quality degradation.

In order to achieve the above object, the stream recording/reproducing apparatus of the present invention is a stream recording/reproducing apparatus that records a first stream onto a first recording medium and then dubs the first stream onto a second recording medium, the apparatus including: a judgment unit that judges whether or not the first stream is compliant with a logic specification of the second recording medium; a first stream recording unit that records the first stream onto the first recording medium; a judgment result recording unit that records a result of the judgment obtained by the judgment unit onto the first recording medium; a conversion unit that converts the first stream recorded on the first recording medium into a second stream that is compliant with the logic specification of the second recording medium in the case where the result of the judgment recorded on the first recording medium indicates that the first stream is not compliant with the logic specification of the second recording medium; and a second stream recording unit that records the second stream onto the second recording medium.

Accordingly, in the case of dubbing, onto the second recording medium, the first stream compliant with the logic specification of the second recording medium, there is no need to decode or encode the first stream again, and thus it is possible to dub the first stream at high speed after simply performing system encoding.

For example, the conversion unit decodes the first stream, and encodes a signal obtained by the decoding into the second stream that is compliant with the logic specification of the second recording medium.

In the case where first stream includes a video elementary stream and an audio elementary stream, the conversion unit stores data into User_data in a Group of Picture layer, the data being the same as subtitle data included in User_data in a Picture layer of the video elementary stream.

The judgment unit may (i) judge whether or not the first stream is compliant with the logic specification of the second recording medium from when the recording of the first stream onto the first recording medium starts until when the recording ends, and (ii) judge that the first stream is compliant with the logic specification of the second recording medium only in the case where all portions constituting the first stream are compliant with the logic specification of the second recording medium.

The judgment unit may (i) judge whether or not the first stream is compliant with the logic specification of the second recording medium for a predetermined first period and for a predetermined second period, the first period starting from when the recording of the first stream onto the first recording medium starts and the second period starting from when a change of sequences occurs in the first stream, and (ii) judge that the first stream is compliant with the logic specification of the second recording medium only in the case where all portions corresponding to the first period and second period are compliant with the logic specification of the second recording medium, the all portions constituting the first stream.

The judgment unit may judge whether or not the first stream is compliant with the logic specification of the second recording medium for a predetermined first period and for a predetermined second period, the first period starting from when the recording of the first stream onto the first recording medium starts and the second period starting from when a change of sequences occurs in the first stream, and the judgment result recording unit may record, onto the first recording medium, a result of the judgment obtained by the judgment unit on a sequence-by-sequence basis.

The judgment unit may judge a logic specification of the first stream, and the judgment result recording unit may record at least one of the following onto the first recording medium in the case where the judgment unit judges that a portion constituting the first stream is not compliant with the logic specification of the second recording medium: a type of a parameter indicating the logic specification of the portion; and a position of the parameter on the first stream.

Furthermore, the stream recording/reproducing apparatus of the present invention is a stream recording/reproducing apparatus that records a first stream onto a first recording medium and then dubs the first stream onto a second recording medium, the apparatus including: a judgment unit that judges whether or not the first stream is compliant with a logic specification of the second recording medium; a conversion unit that converts the first stream into a second stream that is compliant with the logic specification of the second recording medium; a first recording unit that records the second stream onto the first recording medium in the case where the judgment unit judges that the first stream is not compliant with the logic specification of the second recording medium; and a second recording unit that records the second stream recorded on the first recording medium onto the second recording medium.

As described above, the stream recording/reproducing apparatus of the present invention converts the first stream into the second stream that is compliant with the logic specification of the second recording medium in the case where such first stream is not compliant with the logic specification of the second recording medium. Accordingly, when dubbing the first stream onto the second recording medium, the stream recording/reproducing apparatus of the present invention can dub it at high speed after simply performing system encoding.

For example, the conversion unit decodes the first stream, and encodes a signal obtained by the decoding into the second stream that is compliant with the logic specification of the second recording medium.

In the case where the first stream includes a video elementary stream and an audio elementary stream, the conversion unit stores data into User_data in a Group of Picture layer, the data being the same as subtitle data included in User_data in a Picture layer of the video elementary stream.

The judgment unit may judge whether or not the first stream is compliant with the logic specification of the second recording medium before the first recording unit starts the recording.

Furthermore, the stream recording/reproducing apparatus of the present invention is a stream recording/reproducing apparatus that records a first stream onto a first recording medium and then dubs the first stream onto a second recording medium, the apparatus including: a judgment unit that judges whether or not the first stream is compliant with a logic specification of the second recording medium; a conversion unit that converts the first stream into a second stream that is compliant with the logic specification of the second recording medium; a first recording unit that records the first stream and the second stream onto the first recording medium; a deletion unit that (i) deletes the first stream recorded on the first recording medium in the case where the judgment unit judges that a portion constituting the first stream is not compliant with the logic specification of the second recording medium, and (ii) deletes the second stream recorded on the first recording medium in the case where the judgment unit judges that all portions constituting the first stream are compliant with the logic specification of the second recording medium; and a second recording unit that records the stream remaining on the first recording medium onto the second recording medium.

As described above, the stream recording/reproducing apparatus of the present invention leaves, on the first recording medium, only the stream compliant with the logic specification of the second recording medium in the case of recording the first stream onto the first recording medium. Accordingly, when dubbing the first stream onto the second recording medium, the stream recording/reproducing apparatus of the present invention can dub it at high speed after simply performing system encoding. Also, since only the stream compliant with the logic specification of the second recording medium remains on the first recording medium at the completion of the recording, no extra recording capacity of the first recording medium is used.

For example, the conversion unit decodes the first stream, and encodes a signal obtained by the decoding into the second stream that is compliant with the logic specification of the second recording medium.

As described above, the present invention can provide a stream recording/reproducing apparatus that records a stream such as video onto a first recording medium without using extra recording capacity of such first recording medium, and then dubs the stream onto a second recording medium at high speed while minimizing quality degradation.

It is possible to embody the present invention as: a stream recording/reproducing method that includes, as its steps, the characteristic constituent elements of the stream recording/reproducing apparatus of the present invention; a program that causes a computer to execute these steps; and an integrated circuit. The above program can be distributed on a recording medium such as a CD-ROM and over a transmission medium such as a communication network.

The disclosure of Japanese Patent Application No. 2004-204367 filed on Jul. 12, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the stream recording/reproducing apparatus of a first embodiment;

FIG. 2 is a diagram showing the logic specification of a video ES included in a TS of the digital broadcasting and the DVD-VR specification for video;

FIG. 3 is a diagram showing the logic specification of an audio ES included in a TS of the digital broadcasting and the DVD-VR specification for audio;

FIG. 4 is a diagram showing the settings of a SW 51 and a SW 52 at the time of dubbing, in the first embodiment;

FIG. 5A is a diagram showing a structure of a digital broadcasting stream in which subtitle data is stored in the User_data in its Picture layer;

FIG. 5B is a diagram showing a structure of a digital broadcasting stream in which subtitle data is stored in the User_data in its GOP layer and in the User_Data in its Picture layer;

FIG. 5C is a diagram showing a structure of a digital broadcasting stream in which subtitle data is stored in the User_data in its GOP layer;

FIG. 6 is a block diagram showing the stream recording/reproducing apparatus that performs ES processing at the time of dubbing by performing decoding and encoding, in the first embodiment;

FIG. 7 is a block diagram showing a stream recording/reproducing apparatus of a second embodiment;

FIG. 8 is a block diagram showing the stream recording/reproducing apparatus that performs ES processing at the time of recording by performing decoding and encoding, in the second embodiment; and

FIG. 9 is a block diagram showing a stream recording/reproducing apparatus of a third embodiment.

### BEST MODE FOR CARRYING OUT THE INVENTION

The following describes the best modes for carrying out the present invention with reference to the drawings.

### First Embodiment

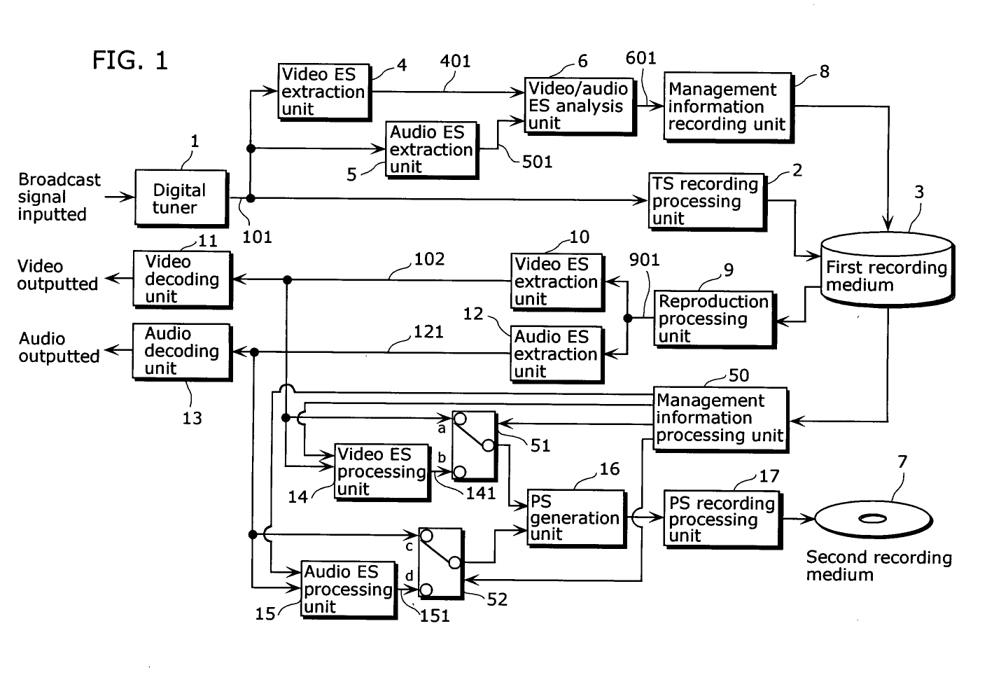

Referring to FIG. 1 to FIGS. 5A-5C, a description is given of the stream recording/reproducing apparatus of the first embodiment.

FIG. 1 is a block diagram showing the stream recording/reproducing apparatus of the first embodiment.

First, a description is given of an operation performed by the stream recording/reproducing apparatus when recording a digital broadcast stream onto a first recording medium 3.

A digital tuner 1 decodes a broadcast signal from an antenna terminal and performs partial processing on the decoded signal so as to generate a partial stream 101 made up of the video packets and audio packets of a selected program. The partial stream 101 is a transport stream (hereinafter also referred to as “TS”) that is made up of a large number of 188-byte packets.

The partial stream 101 is inputted to a TS recording processing unit 2. The TS recording processing unit 2 records the partial stream 101 onto the first recording medium 3 after performing processing for recording it onto the first recording medium 3. An example of the processing performed by the TS recording processing unit 2 is the assignment of time stamps to the respective packets. Meanwhile, media in which transport streams can be recorded include Blu-ray Disc, HDD, and the like. In other words, the first recording medium 3 is a Blu-ray Disc, an HDD, or the like. The embodiments assume the case where the first recording medium 3 is an HDD.

The partial stream 101 is inputted also to a video elementary stream (hereinafter referred to as “ES”) extraction unit 4 and an audio ES extraction unit 5. The video ES extraction unit 4 selects video packets, in the inputted partial stream 101, whose identifier (PID) in the packet header is a predetermined value, and extracts only the payloads of such packets. Through this, the video ES extraction unit 4 extracts a video ES 401. The audio ES extraction unit 5 selects audio packets, in the partial stream 101, whose PID in the packet header is a predetermined value, and extracts only the payloads of such packets. Through this, the audio ES extraction unit 5 extracts an audio ES 501.

The video ES 401 and the audio ES 501 are inputted to a video/audio ES analysis unit 6. The video/audio ES analysis unit 6 judges whether or not the inputted video ES 401 and audio ES 501 are each compliant with the logic specification of a second recording medium 7.

The embodiments assume the case where the second recording medium 7 is a DVD-RAM. The embodiments also assume the case where the logic format of data recordable onto the second recording medium 7, i.e., the logic specification of the second recording medium 7, is the DVD-Video Recording (hereinafter referred to as “DVD-VR”) specification.

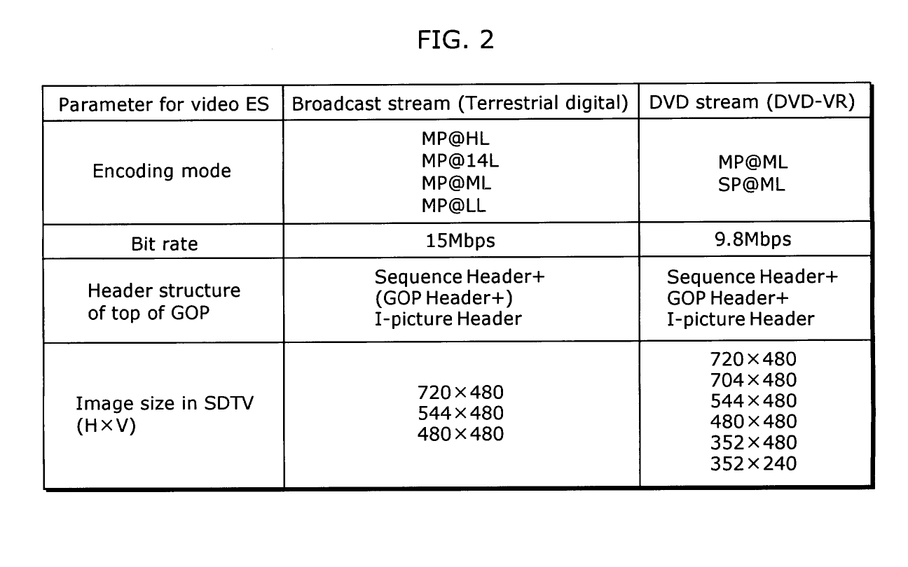

FIG. 2 is a diagram showing, in comparison, the logic specification of a video ES included in a TS of the terrestrial digital broadcasting in Japan and the DVD-VR specification for video.

As shown in FIG. 2, while the broadcast stream specification supports “MP@HL” of MPEG2 as “Encoding mode”, the DVD-VR specification does not support “MP@HL”. Meanwhile, “MP@ML” is supported both by the broadcast stream specification and the DVD-VR specification. Furthermore, in an example shown in the comparison table of FIG. 2, while “Bit rate” of the broadcast stream specification is “15 Mbps or lower”, “Bit rate” of the DVD-VR specification is “9.8 Mbps or lower”. Regarding “Header structure at top of GOP”, while “GOP header” may be or may not be included in the case of the broadcast stream specification, “GOP header” must be included in the case of the DVD-VR specification. Furthermore, regarding “Image size in SDTV (H×V)”, while the broadcast stream specification supports “720×480”, “544×480”, and “480×480”, the DVD-VR specification supports any of these as well as “704×480” and the like that is different from any of them. Note that information for identifying “Bit rate” is included in the video ES 401 at a ratio of one in every 0.5 seconds. Alternatively, the video ES extraction unit 4 may measure “Bit rate”, and incorporate the measurement result at a ratio of one in every 0.5 seconds as information for identifying “Bit rate”.

The video/audio ES analysis unit 6 analyzes the video ES 401 to extract the values of various parameters, and judges whether or not the video ES 401 is compliant with the DVD-VR specification by judging whether or not the extracted parameters are included in the column of the DVD-VR specification in the comparison table shown in FIG. 2. In the case where the extracted parameters are included in the column of the DVD-VR specification in the comparison table shown in FIG. 2, the video/audio ES analysis unit 6 judges that the video ES 401 is compliant with the DVD-VR specification. Note that in the case where the video ES extraction unit 4 measures “Bit rate”, the video/audio ES analysis unit 6 judges whether or not such measured “Bit rate” is compliant with the DVD-VR specification (9.8 Mbps or lower) based on information for identifying “Bit rate”.

Similarly, the video/audio ES analysis unit 6 judges whether or not the audio ES 501 is compliant with the DVD-VR specification.

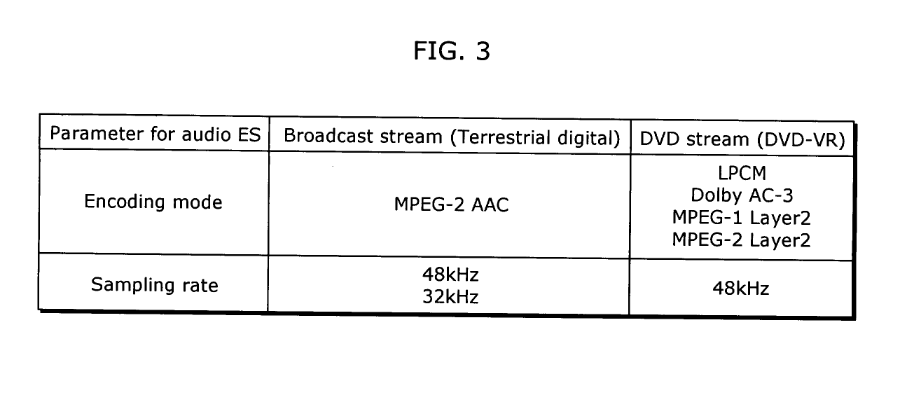

FIG. 3 is a diagram showing, in comparison, the specification of an audio ES included in a TS of the terrestrial digital broadcasting in Japan and the DVD-VR specification for audio. In an example shown in FIG. 3, while the broadcast stream specification supports “MPEG2-AAC” as “Encoding method”, the DVD-VR specification does not support it. Also, while “Sampling rate” of the broadcast stream specification is “48 kHz” or “32 kHz”, “Sampling rate” of the DVD-VR specification is “48 kHz”.

The video/audio ES analysis unit 6 analyzes the audio ES 501 to extract the values of various parameters, and judges whether or not the audio ES 501 is compliant with the DVD-VR specification by judging whether or not the extracted parameters are included in the column of the DVD-VR specification in the comparison table shown in FIG. 3. In the case where the extracted parameters are included in the column of the DVD-VR specification in the comparison table shown in FIG. 3, the video/audio ES analysis unit 6 judges that the audio ES 501 is compliant with the DVD-VR specification.

The video/audio ES analysis unit 6 holds the comparison tables shown in FIG. 2 and FIG. 3.

Note that the comparison tables shown in FIG. 2 and FIG. 3 are examples of a comparison between the specifications of ESs in broadcasting and the DVD-VR specification. The video/audio ES analysis unit 6 checks parameters other than the parameters shown in FIG. 2 and FIG. 3 in actuality.

The video/audio ES analysis unit 6 continuously makes the above judgments about the video ES 401 and the audio ES 501 from when the TS recording processing unit 2 starts the recording of the partial stream 101 onto the first recording medium 3 until when it ends the recording. The video/audio ES analysis unit 6 outputs the judgment results to a management information recording unit 8 as a part of an analysis result 601. In the case of judging that the video ES 401 is not compliant with the DVD-VR specification, the video/audio ES analysis unit 6 outputs parameters indicating the specification of the video ES 401 to the management information recording unit 8 as a part of the analysis result 601. Meanwhile, in the case of judging that the audio ES 501 is not compliant with the DVD-VR specification, the video/audio ES analysis unit 6 outputs parameters indicating the specification of the audio ES 501 to the management information recording unit 8 as a part of the analysis result 601.

Immediately after the recording of the partial stream 101 onto the first recording medium 3 completes, the management information recording unit 8 records, onto the first recording medium 3, the respective judgment results indicating whether or not the video ES 401 and the audio ES 501 are compliant with the DVD-VR specification, as a part of management information. In the case where one of the video ES 401 and the audio ES 501 is not compliant with the DVD-VR specification, the management information recording unit 8 records, onto the first recording medium 3, parameters indicating the specification of the ES that is not complaint with the DVD-VR specification, as a part of the management information.

Accordingly, the partial stream 101, being a digital broadcast stream, is recorded onto the first recording medium 3 together with the management information that includes the judgment results or the like indicating whether or not the ESs constituting such partial stream 101 are compliant with the DVD-VR specification. In the case where an ES constituting the partial stream 101 is not compliant with the DVD-VR specification, non-compliance information including the value of a parameter of such ES that is not compliant with the DVD-VR specification, is also recorded onto the first recording medium 3.

Next, a description is given of an operation performed by the stream recording/reproducing apparatus when reproducing the partial stream 101 recorded on the first recording medium 3.

In response to an instruction to reproduce the recorded partial stream 101, the partial stream 101 is inputted to a reproduction processing unit 9 from the first recording medium 3.

The reproduction processing unit 9 outputs a reproduction TS 901 after performing processing for reproducing the partial stream 101. The reproduction TS 901 is inputted to a video ES extraction unit 10 and an audio ES extraction unit 12.

The video ES extraction unit 10 selects video packets, in the reproduction TS 901, whose PID in the packet header is a predetermined value, and extracts only the payloads of such packets. Through this, the video ES extraction unit 10 extracts a video ES 102. The audio ES extraction unit 12 selects audio packets, in the reproduction TS 901, whose PID in the packet header is a predetermined value, and extracts only the payloads of such packets. Through this, the audio ES extraction unit 12 extracts an audio ES 121.

The video ES 102 is inputted to a video decoding unit 11. The video decoding unit 11 generates a video signal by decoding the video ES 102, and outputs it. The audio ES 121 is inputted to an audio decoding unit 13. The audio decoding unit 13 generates an audio signal by decoding the audio ES 121, and outputs it. The partial stream 101 recorded on the first recording medium 3 is reproduced in the above manner.

Next, a description is given of an operation performed by the stream recording/reproducing apparatus when dubbing the partial stream 101 recorded on the first recording medium 3 onto the second recording medium 7.

In response to an instruction to dub the recorded partial stream 101, the partial stream 101 is inputted to the reproduction processing unit 9 from the first recording medium 3. Furthermore, the management information obtained by the video/audio ES analysis unit 6 is inputted from the first recording medium 3 to a management information processing unit 50, the management information being the judgment results or the like indicating whether or not the respective ESs constituting the partial stream 101 are compliant with the DVD-VR specification.

The reproduction processing unit 9 outputs the reproduction TS 901 after performing processing for reproducing the partial stream 101.

The management information processing unit 50 obtains, from the management information, type information indicating whether or not the video ES and the audio ES constituting the partial stream 101 are each compliant with the logic specification of the destination recording medium (the second recording medium 7). The type information can come in four different combinations since each of the video ES and audio ES is or is not compliant with the logic specification of the second recording medium 7.

The reproduction TS 901 is inputted to the video ES extraction unit 10 and the audio ES extraction unit 12. The video ES extraction unit 10 extracts the video ES 102 by selecting video packets, in the inputted reproduction TS 901, whose PID in the packet header is a predetermined value and extracting only the payloads of such packets. The audio ES extraction unit 12 extracts the audio ES 121 in a similar manner to that of the video ES extraction unit 10.

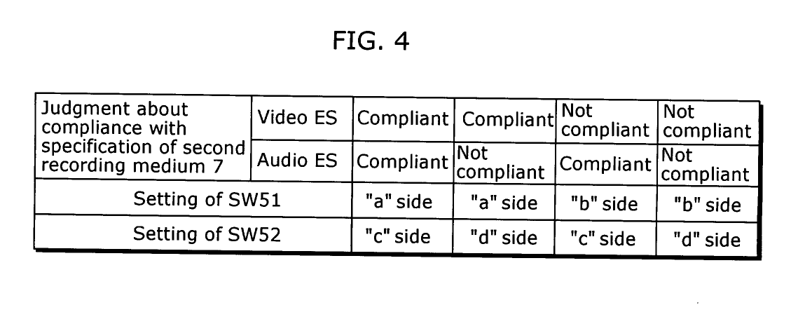

The management information processing unit 50 sets a SW 51 and a SW 52 according to one of the settings shown in FIG. 4, depending on which one of the above-described four types the type information applies to.

In other words, in the case where the video ES is compliant with the logic specification of the second recording medium 7, the management information processing unit 50 causes the SW 51 to select an input on the “a” side. Meanwhile, in the case where the video ES is not compliant with the logic specification of the second recording medium 7, the management information processing unit 50 causes the SW 51 to select an input on the “b” side, and outputs, to the video ES processing unit 14, non-compliance information including the value of a parameter of the video ES that is not compliant with the logic specification of the second recording medium 7. Using the non-compliance information, the video ES processing unit 14 converts the video ES 102 into a video ES 141 that is compliant with the logic specification of the second recording medium 7, and outputs the video ES 141 to the PS generation unit 16.

Regarding audio, in the case where the audio ES is compliant with the logic specification of the second recording medium 7, the management information processing unit 50 causes the SW 52 to select an input on the “c” side. Meanwhile, in the case where the audio ES is not compliant with the logic specification of the second recording medium 7, the management information processing unit 50 causes the SW 52 to select an input on the “d” side, and outputs, to the audio ES processing unit 15, non-compliance information including the value of a parameter of the audio ES that is not compliant with the logic specification of the second recording medium 7. Using the non-compliance information, the audio ES processing unit 15 converts the audio ES 121 into an audio ES 151 that is compliant with the logic specification of the second recording medium 7, and outputs the audio ES 151 to the PS generation unit 16.

As a result, the video ES 102 is inputted directly to a PS generation unit 16 in the case where it is compliant with the logic specification of the second recording medium 7 being the destination recording medium. Meanwhile, in the case where the video ES 102 is not compliant with the logic specification of the second recording medium 7, the video ES processing unit 14 converts the video ES 102 into a video ES 141 that is compliant with the logic specification of the second recording medium 7, and outputs the video ES 141 to the PS generation unit 16.

Similarly, the audio ES 121 is inputted directly to the PS generation unit 16 in the case where it is compliant with the logic specification of the second recording medium 7 being the destination recording medium. Meanwhile, in the case where the audio ES 121 is not compliant with the logic specification of the second recording medium 7, the audio ES processing unit 15 converts the audio ES 121 into an audio ES 151 that is compliant with the logic specification of the second recording medium 7, and outputs the audio ES 151 to the PS generation unit 16.

The PS generation unit 16 generates a program stream (hereinafter referred to as “PS”) by multiplexing the video ES 102 or the video ES 141 with the audio ES 121 or the audio ES 151.

A PS recording processing unit 17 records the generated PS onto the second recording medium 7 after performing processing for recording the generated PS.

The partial stream 101 recorded on the first recording medium 3 is dubbed onto the second recording medium 7 in the above manner.

As described above, in the case of dubbing, onto the second recording medium 7, the partial stream 101 compliant with the logic specification of the second recording medium 7, no decoding or encoding is performed on the partial stream 101. Only system encoding is performed on the partial stream 101. Accordingly, in the case where the partial stream 101 is compliant with the logic specification of the second recording medium 7, it is possible to dub the partial stream 101 onto the second recording medium 7 at high speed while minimizing the degradation in image quality and sound quality, without using extra recording capacity of the first recording medium 3.

Next, a description is given of an example of processing performed by the video ES processing unit 14.

As shown in FIG. 2, the terrestrial digital broadcasting in Japan does not require the inclusion of a GOP header in a video ES. In contrast, the DVD-VR specification requires the inclusion of a GOP header in a video ES. Thus, in the case where a broadcast TS including no GOP header in its video ES is recorded onto the first recording medium 3, the video/audio ES analysis unit 6 detects that no GOP header is included, and the management information recording unit 8 records such information onto the first recording medium 3 as a part of the management information.

In the case where such broadcast TS including no GOP header is dubbed onto the second recording medium 7, the video ES 102 extracted from the reproduction TS 901 is inputted to the video ES processing unit 14. Furthermore, the management information processing unit 50 obtains, from the first recording medium 3, information indicating that the stream to be dubbed does not include any GOP headers, and transfers the information to the video ES processing unit 14. The video ES processing unit 14 generates the video ES 141 compliant with the logic specification of the second recording medium 7 by inserting a GOP header immediately after the Sequence header. The video ES 141 is multiplexed with the audio ES by the PS generation unit 16.

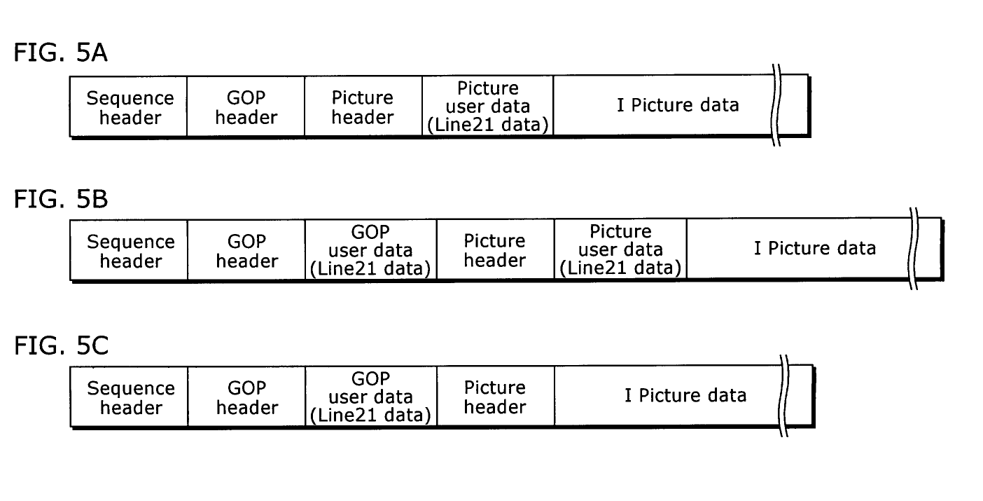

Referring to FIG. 5A to FIG. 5C, a description is given of another example of processing performed by the video ES processing unit 14.

In the digital broadcasting in the North America, there is the case where subtitle data (Line 21 data) is included in the User_data in the Picture layer of a video ES. FIG. 5A shows a stream structure of the top of a GOP. In contrast, the DVD-VR specification stipulates that subtitle data should be placed in the User_data in the GOP layer.

In the case where the subtitle data is included in the User_data in the Picture layer, the video/audio ES analysis unit 6 detects that the subtitle data is included in the User_data in the Picture layer of the video ES, and the management information recording unit 8 records such information onto the first recording medium 3 as a part of the management information.

In the case of dubbing, onto the second recording medium 7, the above stream whose video ES includes the subtitle data in the User_data in the Picture layer, the video ES 102 extracted from the reproduction TS 901 is inputted to the video ES processing unit 14. Furthermore, the management information processing unit 50 obtains, from the first recording medium 3, information indicating that the video ES to be dubbed includes the subtitle data in the User_data in the Picture layer, and transfers the information to the video ES processing unit 14.

The video/audio ES processing unit 14 stores the same data as that of the subtitle data included in the User_data in the Picture layer into the User_data in the GOP layer, based on the information, from the management information processing unit 50, indicating that the subtitle data is included in the User_data in the Picture layer of the video ES. Through this, a video ES compliant with the DVD-VR specification is generated. Note that the User_data included in the Picture layer may remain there as shown in FIG. 5B or may be deleted as shown in FIG. 5C.

Next, a description is given of an example of processing performed by the audio ES processing unit 15.

As shown in FIG. 3, in the digital broadcasting in Japan, an audio ES is an audio stream that is compressed in accordance with MPEG2-AAC. MPEG2-AAC is a compression mode that is not supported by the DVD-VR specification. Thus, in the case where the audio ES is an audio stream that is compressed in accordance with MPEG2-AAC, the video/audio ES analysis unit 6 detects that the audio ES is an audio stream that is compressed in accordance with MPEG2-AAC, and the management information recording unit 8 records such information onto the first recording medium 3 as a part of the management information.

In the case of dubbing, onto the second recording medium 7, the above audio ES that is compressed in accordance with MPEG2-AAC, the audio ES 121 extracted from the reproduction TS 901 is inputted to the audio ES processing unit 15. Furthermore, the management information processing unit 50 obtains, from the first recording medium 3, information indicating that the audio ES 121 is an audio stream that is compressed in accordance with MPEG2-AAC, and transfers the information to the audio ES processing unit 15. The audio ES processing unit 15 decodes the audio ES 121 that is compressed in accordance with MPEG2-AAC into an audio signal, and then encodes such audio signal again into a Dolby-AC3 stream. Through this, the audio ES processing unit 15 generates an audio ES 151 compliant with the DVD-VR specification. The audio ES 151 is multiplexed with the video ES by the PS generation unit 16.

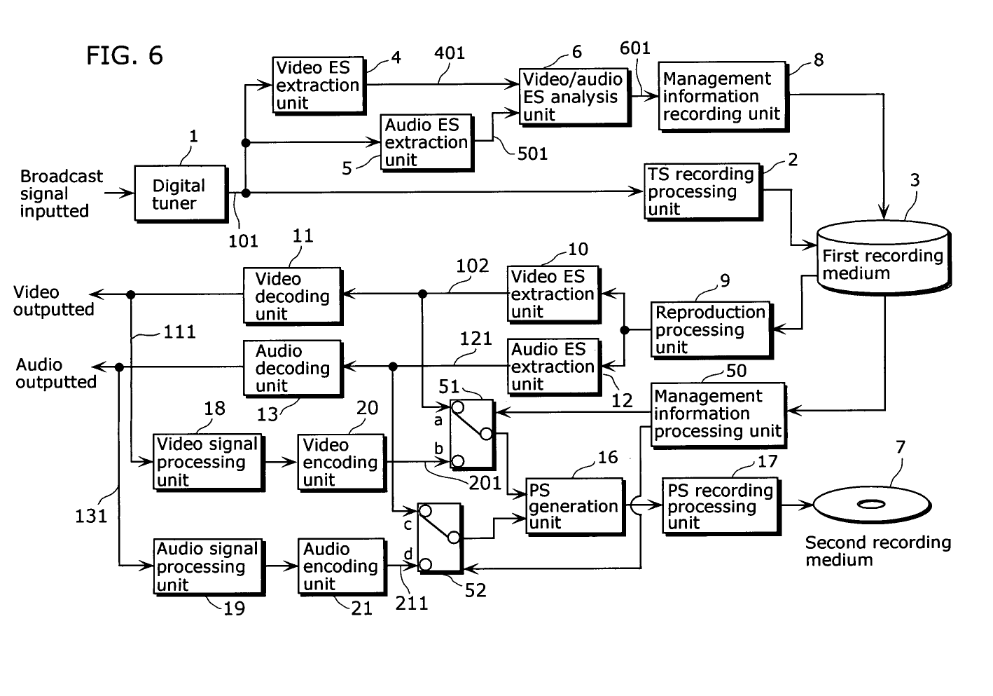

Note that as shown in FIG. 6, at the time of dubbing, the video decoding unit 11 may decode the video ES, and the resulting video signal 111 may be inputted to a video signal processing unit 18. In this case, the video signal processing unit 18 performs processing described below on the video signal 111, and a video encoding unit 20 encodes the processed video signal based on the logic specification of the second recording medium 7, and outputs the encoded video signal to the SW 51. Regarding audio, the audio decoding unit 13 may decode the audio ES, and the resulting audio signal 131 may be inputted to an audio signal processing unit 19. In this case, the audio signal processing unit 19 performs processing described below on the audio signal 131, and the audio encoding unit 21 encodes the processed audio signal based on the logic specification of the second recording medium 7, and outputs the encoded audio signal to the SW 52.

The video signal processing unit 18 performs processing such as size conversion of high-definition video into standard video, for example. Furthermore, in the case where the video ES from the first recording medium 3 includes subtitle data, the video signal processing unit 18 encodes the video ES so that subtitle data is placed in both the User_data in the Picture layer and the User_data in the GOP layer as described above.

The audio signal processing unit 19 performs processing such as conversion of the sampling frequency of the audio signal, for example. As shown in FIG. 3, while the DVD-VR specification supports only the sampling performed at 48 kHz, there is the case where sampling is performed at another sampling frequency such as 32 kHz in digital broadcasting. In such case, the audio signal processing unit 19 converts the sampling frequency of the audio signal.

Note that in the above-described first embodiment, the video/audio ES analysis unit 6 continuously makes judgments of whether or not the video ES 401 and the audio ES 501 are compliant with the logic specification of the second recording medium 7 from the start to the end of the recording of the partial stream 101 onto the first recording medium 3. However, the video/audio ES analysis unit 6 may make the above judgments only for a predetermined period after the recording of the partial stream 101 onto the first recording medium 3 starts. Alternatively, the video/audio ES analysis unit 6 may make the above judgments for a predetermined period after the recording of the partial stream 101 onto the first recording medium 3 starts and for a predetermined period immediately after there is a change in video or audio sequences. In the latter case, the management information recording unit 8 records the judgment results (analysis result 601) for each video or audio sequence, and the SW 51 and the SW 52 switch inputs on a sequence basis depending on judgment results at the time of dubbing.

In the case where the video/audio ES analysis unit 6 judges that a portion constituting the partial stream 101 is not compliant with the logic specification of the second recording medium 7 as a result of judging the logic specification of the partial stream 101, the management information recording unit 8 may record, onto the first recording medium 3, the type of the parameter indicating the logic specification of such portion judged by the video/audio ES analysis unit 6 as not being compliant with the logic specification of the second recording medium 7. In the above case, the management information recording unit 8 may alternatively record, onto the first recording medium 3, the position of the above parameter on the partial stream 101. The type of the parameter is, for example, “parameter indicating the presence or absence of a GOP header” and “parameter indicating a layer in which subtitle data is included”.

When “parameter indicating the presence or absence of a GOP header” as the type of the parameter is recorded on the first recording medium 3, the video ES processing unit 14 inserts a GOP header immediately after the Sequence header at the time of dubbing for the portion constituting the partial stream 101 judged as not being compliant with the logic specification of the second recording medium 7. This allows the video ES processing unit 14 to generate, at high speed, the video ES 141 compliant with the logic specification of the second recording medium 7.

When the position on the partial stream 101 at which a GOP header should be included (position immediately after the Sequence header) is recorded on the first recording medium 3, the video ES processing unit 14 can generate, at a higher speed, the video ES 141 compliant with the logic specification of the second recording medium 7 since the video ES processing unit 14 knows where to insert the GOP header.

When “parameter indicating a layer in which subtitle data is included” as the type of the parameter is recorded on the first recording medium 3, the video ES processing unit 14 inserts, into the User_data in the GOP layer, the data same as the subtitle data included in the User_data in the Picture layer at the time of dubbing for the portion constituting the partial stream 101 judged as not being compliant with the logic specification of the second recording medium 7. This allows the video ES processing unit 14 to generate, at high speed, the video ES 141 compliant with the logic specification of the second recording medium 7.

When the position on the partial stream 101 at which subtitle data should be included (position immediately after the GOP header) is recorded on the first recording medium 3, the video ES processing unit 14 can generate, at a higher speed, the video ES 141 compliant with the logic specification of the second recording medium 7 since the video ES processing unit 14 knows that the subtitle data should be inserted at the position of the User_data in the GOP layer.

In the first embodiment, the video/audio ES analysis 6 is an example of the judgment unit of the stream recording/reproducing apparatus of the present invention. The TS recording processing unit 2 is an example of the first stream recording unit of the stream recording/reproducing apparatus of the present invention. The management information recording unit 8 is an example of the judgment result recording unit of the stream recording/reproducing apparatus of the present invention. The video ES processing unit 14 and the audio ES processing unit 15 are an example of the conversion unit of the stream recording/reproducing apparatus of the present invention. The PS recording processing unit 17 is an example of the second stream recording unit of the stream recording/reproducing apparatus of the present invention.

### Second Embodiment

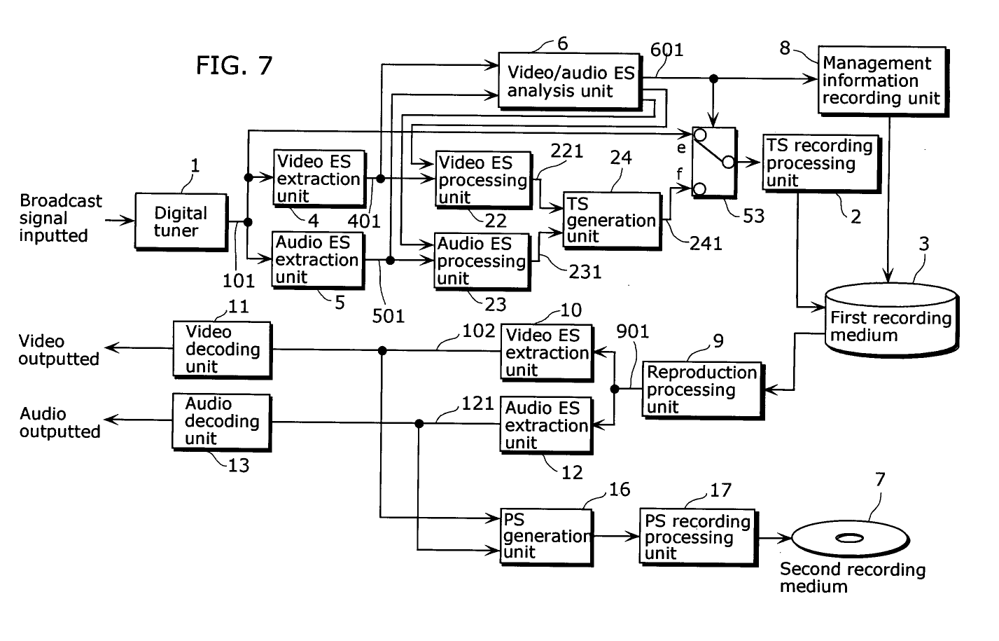

Referring to FIG. 7, a description is given of a stream recording/reproducing apparatus of the second embodiment.

FIG. 7 is a block diagram showing the stream recording/reproducing apparatus of the second embodiment.

First, a description is given of an operation performed by the stream recording/reproducing apparatus when recording a digital broadcast stream.

The digital tuner 1 decodes a broadcast signal from an antenna terminal and performs partial processing on the decoded signal so as to generate a partial stream 101 made up of the video packets and audio packets of a selected program. The partial stream 101 is inputted to the video ES extraction unit 4 and the audio ES extraction unit 5. The video ES extraction unit 4 selects video packets, in the inputted partial stream 101, whose PID in the packet header is a predetermined value, and extracts only the payloads of such packets. Through this, the video ES extraction unit 4 extracts a video ES 401. The audio ES extraction unit 5 extracts an audio ES 501 in a similar manner to that of the video ES extraction unit 4.

The video ES 401 is inputted to the video ES processing unit 22. The video ES processing unit 22 converts the video ES 401 into a video ES 221 that is compliant with both the logic specification of the first recording medium 3 being the medium where the video ES 401 is directly recorded and the logic specification of the second recording medium 7 being the destination recording medium.

The audio ES 501 is inputted to the audio ES processing unit 23. The audio ES processing unit 23 converts the audio ES 501 into an audio ES 231 that is compliant with both the logic specification of the first recording medium 3 being the medium where the audio ES 501 is directly recorded and the logic specification of the second recording medium 7 being the destination recording medium.

The video ES 221 outputted from the video ES processing unit 22 and the audio ES 231 outputted from the audio ES processing unit 23 are inputted to a TS generation unit 24. The TS generation unit 24 generates a converted TS 241 by multiplexing the video ES 221 and the audio ES 231.

Also, the partial stream 101 is inputted to the TS generation unit 24 as it is.

The video ES 401 and the audio ES 501 are inputted also to the video/audio ES analysis unit 6. The video/audio ES analysis unit 6 judges whether or not the inputted video ES 401 and audio ES 501 are each compliant with the logic specification of the second recording medium 7. Details of the judgments are the same as those described in the first embodiment, and therefore their descriptions are not given.

In the case where the video ES 401 is not compliant with the logic specification of the second recording medium 7 (DVD-VR specification), the video/audio ES analysis unit 6 outputs, to the video ES processing unit 22, non-compliance information including the value of a parameter of the video ES that is not compliant with the logic specification of the second recording medium 7. Then, the video ES processing unit 22 performs the above-described conversion using such non-compliance information. In the case where the audio ES 501 is not compliant with the logic specification of the second recording medium 7, the video/audio ES analysis unit 6 outputs, to the audio ES processing unit 23, non-compliance information including the value of a parameter of the audio ES that is not compliant with the logic specification of the second recording medium 7. Then, the audio ES processing unit 23 performs the above-described conversion using such non-compliance information. The video/audio ES analysis unit 6 outputs the non-compliance information also to a SW 53.

In the case where the video/audio ES analysis unit 6 obtains the analysis result 601 indicating that the video ES 401 and the audio ES 501 are each compliant with the logic specification of the second recording medium 7, the SW 53 selects the “e” side, and the TS recording processing unit 2 records the partial stream 101 onto the first recording medium 3.

Meanwhile, in the case where the video/audio ES analysis unit 6 obtains the analysis result 601 indicating that any of the video ES 401 and the audio ES 501 is not compliant with the logic specification of the second recording medium 7, i.e., the video/audio ES analysis unit 6 outputs the non-compliance information to the SW 53, the SW 53 selects the “f” side based on the non-compliance information. Using the non-compliance information, the video ES processing unit 22 converts the video ES 401 into a video ES 221 that is compliant with both the logic specification of the first recording medium 3 and the logic specification of the second recording medium 7, and outputs the video ES 221 to the TS generation unit 24. Using the non-compliance information, the audio ES processing unit 23 converts the audio ES 501 into an audio ES 231 that is compliant with both the logic specification of the first recording medium 3 and the logic specification of the second recording medium 7, and outputs the audio ES 231 to the TS generation unit 24. The TS generation unit 24 generates a converted TS 241 by multiplexing the video ES 221 and the audio ES 231. The TS recording processing unit 2 records the converted TS 241 onto the first recording medium 3.

The video/audio ES analysis unit 6 makes judgments of whether or not the video ES 401 and the audio ES 501 are each compliant with the logic specification of the second recording medium 7 for a predetermined period before the TS recording processing unit 2 starts the recording processing.

Next, a description is given of an operation performed by the stream recording/reproducing apparatus when reproducing the partial stream 101 or the converted TS 241 recorded on the first recording medium 3.

In response to an instruction to reproduce the recorded content, the partial stream 101 or the converted TS 241 is inputted to a reproduction processing unit 9 from the first recording medium 3.

The reproduction processing unit 9 outputs a reproduction TS 901 after performing processing for reproducing the partial stream 101 or the converted TS 241. The reproduction TS 901 is inputted to the video ES extraction unit 10 and the audio ES extraction unit 12.

The video ES extraction unit 10 selects video packets, in the inputted reproduction TS 901, whose PID in the packet header is a predetermined value, and extracts only the payloads of such packets. Through this, the video ES extraction unit 10 extracts a video ES 102. The audio ES extraction unit 12 extracts an audio ES 121 in a similar manner to that of the video ES extraction unit 10.

The video ES 102 is inputted to the video decoding unit 11. The video decoding unit 11 generates a video signal by decoding the video ES 102, and outputs it. The audio ES 121 is inputted to the audio decoding unit 13. The audio decoding unit 13 generates an audio signal by decoding the audio ES 121, and outputs it.

Accordingly, the partial stream 101 or the converted TS 241 recorded on the first recording medium 3 is reproduced.

Next, a description is given of an operation performed by the stream recording/reproducing apparatus when dubbing the partial stream 101 or the converted TS 241 recorded on the first recording medium 3 onto the second recording medium 7.

In response to an instruction to dub the recorded partial stream 101 or the converted TS 241, the partial stream 101 or the converted TS 241 is inputted to the reproduction processing unit 9 from the first recording medium 3.

The reproduction processing unit 9 outputs a reproduction TS 901 after performing processing for reproducing the partial stream 101 or the converted TS 241.

The reproduction TS 901 is inputted to the video ES extraction unit 10 and the audio ES extraction unit 12, and the video ES 102 and the audio ES 121 are extracted, respectively. The video ES 102 and the audio ES 121 are inputted to the PS generation unit 16, and the PS generation unit 16 generates a PS by multiplexing the video ES 102 and the audio ES 121. The PS recording processing unit 17 records the PS onto the second recording medium 7 after performing processing for recording the PS.

Accordingly, the partial stream 101 or converted TS 241 recorded on the first recording medium 3 is dubbed.

As described above, the partial stream 101 is converted into the converted TS 241 in the case where it is not compliant with the logic specification of the second recording medium 7, and therefore the stream compliant with the logic specification of the second recording medium 7 is recorded onto the first recording medium 3. Accordingly, it is possible to dub the stream recorded on the first recording medium 3 onto the second recording medium 7 at high speed while minimizing the degradation in image quality and sound quality, without using extra recording capacity of the first recording medium 3.

Referring to FIG. 5A to FIG. 5C, a description is given of an example of processing performed by the video ES processing unit 22.

In the digital broadcasting in the North America, there is the case where subtitle data (Line 21 data) is included in the User_data in the Picture layer of a video ES. FIG. 5A shows a stream structure of the top of a GOP. In contrast, the DVD-VR specification stipulates that subtitle data should be placed in the User_data in the GOP layer.

In the case where the subtitle data is included in the User_data in the Picture layer, the video/audio ES analysis unit 6 detects that the subtitle data is included in the User_data in the Picture layer of the video ES, and outputs, to the video ES processing unit 22, information indicating that. Based on such information, from the video/audio ES analysis unit 6, indicating that the subtitle data is included in the User_data in the Picture layer of the video ES, the video ES processing unit 22 stores the same data as that of the subtitle data included in the User_data in the Picture layer into the User_data in the GOP layer. Accordingly, a video ES compliant with the logic specification of the first recording medium 3, i.e., the digital broadcasting specification and the DVD-VR specification, is generated. Note that the User_data in the Picture layer remains there as it is as shown in FIG. 5B.

Details of the other processes performed by the video ES processing unit 22 and the audio ES processing unit 23 are the same as those performed respectively by the video ES processing unit 14 and the audio ES processing unit 15 described in the first embodiment, and therefore their descriptions are not given.

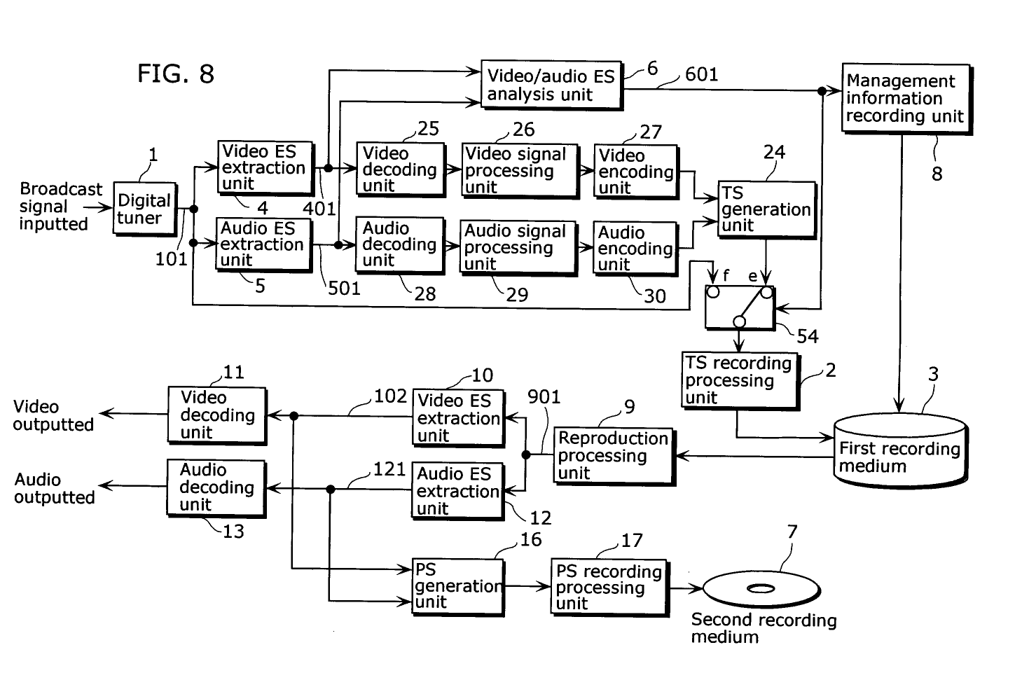

Note that as shown in FIG. 8, at the time of recording, a video decoding unit 25 may decode the video ES 401, and the resulting video signal may be inputted to a video signal processing unit 26. In this case, the video signal processing unit 26 performs the same processing on the video signal as the one performed by the video signal processing unit 18 shown in FIG. 6, and a video encoding unit 27 encodes the processed video signal so that the encoded video signal is compliant with both the logic specification of the first recording medium 3 and the logic specification of the second recording medium 7, and outputs the encoded video signal to the TS generation unit 24.

Regarding audio, an audio decoding unit 28 may decode the audio ES 501, and the resulting audio signal may be inputted to an audio signal processing unit 29. In this case, the audio signal processing unit 29 performs the same processing on the audio signal as the one performed by the audio signal processing unit 19 shown in FIG. 6, and an audio encoding unit 30 encodes the processed audio signal so that the encoded audio signal is compliant with both the logic specification of the first recording medium 3 and the logic specification of the second recording medium 7, and outputs the encoded audio signal to the TS generation unit 24.

Also, the video/audio ES analysis unit 6 may output, to the management information recording unit 8, compliance information indicating whether or not each of the packets constituting the video ES 401 and the audio ES 501 is compliant with the logic specification of the second recording medium 7, and the management information recording unit 8 may record such compliance information onto the first recording medium 3. When this is done, a stream corresponding to a period compliant with the logic specification of the second recording medium 7 may be recorded onto the first recording medium 3 by the TS recording processing unit as they are. Packets not compliant with the logic specification of the second recording medium 7 may be converted by the video ES processing unit 22 and the audio ES processing unit 23 to be recorded onto the first recording medium 3 by the TS recording processing unit 2. In this case, the stream complainant with the logic specification of the second recording medium 7 and the converted stream are concatenated at the time of dubbing processing.

In the second embodiment, the video/audio ES analysis 6 is an example of the judgment unit of the stream recording/reproducing apparatus of the present invention. The video ES processing unit 22 and the audio ES processing unit 23 are an example of the conversion unit of the stream recording/reproducing apparatus of the present invention. The TS recording processing unit 2 is an example of the first recording unit of the stream recording/reproducing apparatus of the present invention. The PS recording processing unit 17 is an example of the second recording unit of the stream recording/reproducing apparatus of the present invention.

### Third Embodiment

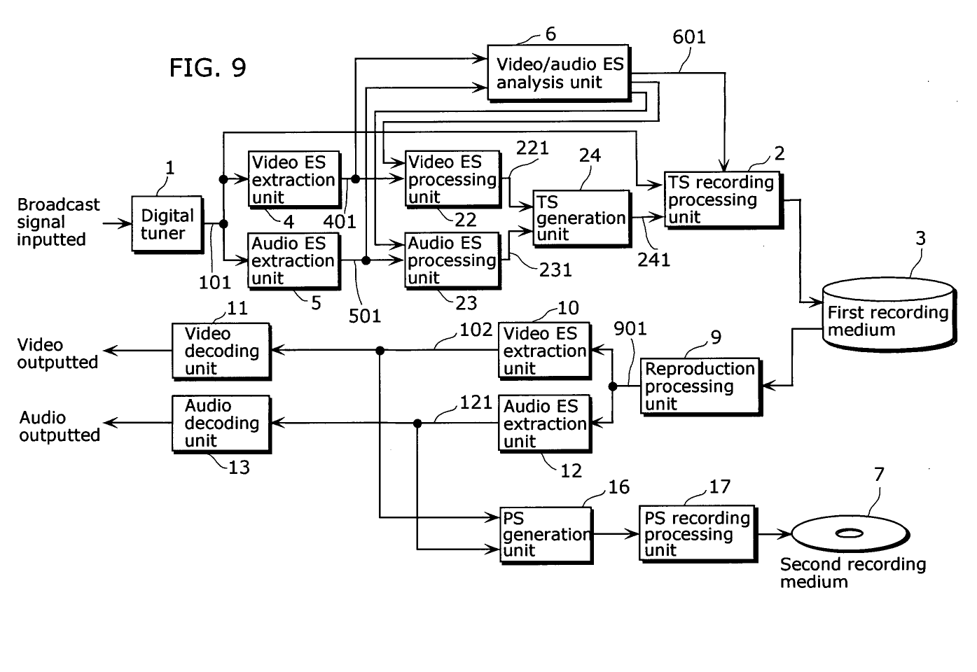

Referring to FIG. 9, a description is given of a stream recording/reproducing apparatus of the third embodiment.

FIG. 9 is a block diagram showing the stream recording/reproducing apparatus of the third embodiment.

First, a description is given of an operation performed by the stream recording/reproducing apparatus when recording a digital broadcast stream.

The digital tuner 1 decodes a broadcast signal from an antenna terminal and performs partial processing on the decoded signal so as to generate a partial stream 101 made up of the video packets and audio packets of a selected program. The partial stream 101 is inputted to the video ES extraction unit 4 and the audio ES extraction unit 5. The video ES extraction unit 4 selects video packets, in the inputted partial stream 101, whose PID in the packet header is a predetermined value, and extracts only the payloads of such packets. Through this, the video ES extraction unit 4 extracts a video ES 401. The audio ES extraction unit 5 extracts an audio ES 501 in a similar manner to that of the video ES extraction unit 4.

The video ES 401 is inputted to the video ES processing unit 22. The video ES processing unit 22 converts the video ES 401 into a video ES 221 that is compliant with both the logic specification of the first recording medium 3 being the medium where the video ES 401 is directly recorded and the logic specification of the second recording medium 7 being the destination recording medium.

The audio ES 501 is inputted to the audio ES processing unit 23. The audio ES processing unit 23 converts the audio ES 501 into an audio ES 231 that is compliant with both the logic specification of the first recording medium 3 being the medium where the audio ES 501 is directly recorded and the logic specification of the second recording medium 7 being the destination recording medium.

The video ES 221 outputted from the video ES processing unit 22 and the audio ES 231 outputted from the audio ES processing unit 23 are inputted to the TS generation unit 24. The TS generation unit 24 generates a converted TS 241 by multiplexing the video ES 221 and the audio ES 231, and outputs it to the TS recording processing unit 2.

The partial stream 101 is also inputted to the TS recording processing unit 2.

The video ES 401 and the audio ES 501 are inputted also to the video/audio ES analysis unit 6. The video/audio ES analysis unit 6 judges whether or not the inputted video ES 401 and audio ES 501 are each compliant with the logic specification of the second recording medium 7. Details of the judgments are the same as those described in the first embodiment, and therefore their descriptions are not given.

In the case where the video ES 401 is not compliant with the logic specification of the second recording medium 7 (DVD-VR specification), the video/audio ES analysis unit 6 outputs, to the video ES processing unit 22, non-compliance information including the value of a parameter of the video ES that is not compliant with the logic specification of the second recording medium 7. Then, the video ES processing unit 22 performs the above-described conversion using such non-compliance information. In the case where the audio ES 501 is not compliant with the logic specification of the second recording medium 7, the video/audio ES analysis unit 6 outputs, to the audio ES processing unit 23, non-compliance information including the value of a parameter of the audio ES that is not compliant with the logic specification of the second recording medium 7. Then, the audio ES processing unit 23 performs the above-described conversion using such non-compliance information.

In the case where the video/audio ES analysis unit 6 outputs the non-compliance information to at least one of the video ES processing unit 22 and the audio ES processing unit 23, the video ES processing unit 22 converts the video ES 401 into a video ES 221 that is compliant with both the logic specification of the first recording medium 3 and the logic specification of the second recording medium 7, using the non-compliance information, and outputs the video ES 221 to the TS generation unit 24. The audio ES processing unit 23 converts the audio ES 501 into an audio ES 231 that is compliant with both the logic specification of the first recording medium 3 and the logic specification of the second recording medium 7, using the non-compliance information, and outputs the audio ES 231 to the TS generation unit 24. The TS generation unit 24 generates a converted TS 241 by multiplexing the video ES 221 and the audio ES 231.

The TS recording processing unit 2 records, onto the first recording medium 3, the partial stream 101 and the converted TS 241. While the TS recording processing unit 2 is performing the recording processing, the video/audio ES analysis unit 6 analyzes whether or not the video ES 401 and the audio ES 501 are compliant with the logic specification of the second recording medium 7.

In the case where it is detected, in the middle of the above recording processing, that at least one of the video ES 401 and the audio ES 501 is not compliant with the logic specification of the second recording medium 7, the TS recording processing unit 2 stops recording the partial stream 101 onto the first recording medium 3, and deletes the already recorded portion of the partial stream 101. The recording of the converted TS 241 continues until an instruction to stop the recording is given, and consequently, it is the converted TS 241 that is finally recorded on the first recording medium 3.

Meanwhile, in the case where it is not detected, until an instruction to stop the recording is given, that any of the video ES 401 and the audio ES 501 is not compliant with the logic specification of the second recording medium 7 (both of them are compliant), the TS recording processing unit 2 deletes the converted TS 241 recorded on the first recording medium 3 after the recording processing completes. Consequently, it is the partial stream 101 that is finally recorded on the first recording medium 3.

Details of the operations to be performed when the partial stream 101 or the converted TS 241 recorded on the first recording medium 3 is reproduced and dubbed are the same as those described in the second embodiment, and therefore their descriptions are not given.

As described above, only the stream compliant with the logic specification of the second recording medium 7 remains on the first recording medium 3. In other words, no extra recording capacity of the first recording medium 3 is used. Furthermore, it is possible to dub the stream recorded on the first recording medium 3 onto the second recording medium 7 at high speed while minimizing the degradation in image quality and sound quality.

Note that the video ES processing at the time of recording may also be performed in the following manner: the video ES 401 is decoded by the video decoding unit, the resulting video signal is processed by the video signal processing unit, the processed video signal is encoded by the video encoding unit so that the encoded video signal is complaint with both the logic specification of the first recording medium 3 and the logic specification of the second recording medium 7, and the encoded video signal is outputted to the TS generation unit 24. Similarly, the audio ES processing at the time of recording may also be performed in the following manner: the audio ES 501 is decoded by the audio decoding unit, the resulting audio signal is processed by the audio signal processing unit, the processed audio signal is encoded by the audio encoding unit so that the encoded audio signal is complaint with both the logic specification of the first recording medium 3 and the logic specification of the second recording medium 7, and the encoded audio signal is outputted to the TS generation unit 24.

The video decoding unit, the video signal processing unit, the video encoding unit, the audio decoding unit, the audio signal processing unit, and the audio encoding unit operate in the same manner respectively as the video decoding unit 11, the video signal processing unit 18, the video encoding unit 20, the audio decoding unit 13, the audio signal processing unit 19, and the audio encoding unit 21 shown in FIG. 6.

In the third embodiment, the video/audio ES analysis unit 6 is an example of the judgment unit of the stream recording/reproducing apparatus of the present invention. The video ES processing unit 22 and the audio ES processing unit 23 are an example of the conversion unit of the stream recording/reproducing apparatus of the present invention. The TS recording processing unit 2 is an example of the first recording unit and the deletion unit of the stream recording/reproducing apparatus of the present invention. The PS recording processing unit 17 is an example of the second recording unit of the stream recording/reproducing apparatus of the present invention.

### INDUSTRIAL APPLICABILITY

The stream recording/reproducing apparatus of the present invention records a transport stream onto a first recording medium after converting it into video and audio elementary streams compliant with the logic specification of the destination recording medium in the case where a program is recorded, for example. In the case where the recorded program is dubbed onto a second recording medium, the stream recording/reproducing apparatus of the present invention performs only system encoding with nothing performed on the elementary streams. As is obvious from the above, the stream recording/reproducing apparatus of the present invention is applicable to uses such one where it is necessary to make an effective use of the recording capacity, for example, of the built-in first recording medium and to dub a recorded program at high speed.

1. A stream recording/reproducing apparatus that records a first stream onto a first recording medium and then dubs the first stream onto a second recording medium, said apparatus comprising:
a judgment unit operable to judge whether or not the first stream is compliant with a logic specification of the second recording medium;
a first stream recording unit operable to record the first stream onto the first recording medium;
a judgment result recording unit operable to record a result of the judgment obtained by said judgment unit onto the first recording medium;
a conversion unit operable to convert the first stream recorded on the first recording medium into a second stream that is compliant with the logic specification of the second recording medium in the case where the result of the judgment recorded on the first recording medium indicates that the first stream is not compliant with the logic specification of the second recording medium; and
a second stream recording unit operable to record the second stream onto the second recording medium.

2. The stream recording/reproducing apparatus according to claim 1,
wherein said conversion unit is operable to decode the first stream, and to encode a signal obtained by the decoding into the second stream that is compliant with the logic specification of the second recording medium.

3. The stream recording/reproducing apparatus according to claim 1,
wherein the first stream includes a video elementary stream and an audio elementary stream, and
said conversion unit is operable to store data into User_data in a Group of Picture layer, the data being the same as subtitle data included in User_data in a Picture layer of the video elementary stream.

4. The stream recording/reproducing apparatus according to claim 1,
wherein said judgment unit is operable (i) to judge whether or not the first stream is compliant with the logic specification of the second recording medium from when the recording of the first stream onto the first recording medium starts until when the recording ends, and (ii) to judge that the first stream is compliant with the logic specification of the second recording medium only in the case where all portions constituting the first stream are compliant with the logic specification of the second recording medium.

5. The stream recording/reproducing apparatus according to claim 1,
wherein said judgment unit is operable (i) to judge whether or not the first stream is compliant with the logic specification of the second recording medium for a predetermined first period and for a predetermined second period, the first period starting from when the recording of the first stream onto the first recording medium starts and the second period starting from when a change of sequences occurs in the first stream, and (ii) to judge that the first stream is compliant with the logic specification of the second recording medium only in the case where all portions corresponding to the first period and second period are compliant with the logic specification of the second recording medium, the all portions constituting the first stream.

6. The stream recording/reproducing apparatus according to claim 1,
wherein said judgment unit is operable to judge whether or not the first stream is compliant with the logic specification of the second recording medium for a predetermined first period and for a predetermined second period, the first period starting from when the recording of the first stream onto the first recording medium starts and the second period starting from when a change of sequences occurs in the first stream, and
said judgment result recording unit is operable to record, onto the first recording medium, a result of the judgment obtained by said judgment unit on a sequence-by-sequence basis.

7. The stream recording/reproducing apparatus according to claim 1,
wherein said judgment unit is operable to judge a logic specification of the first stream, and
said judgment result recording unit is operable to record at least one of the following onto the first recording medium in the case where said judgment unit judges that a portion constituting the first stream is not compliant with the logic specification of the second recording medium: a type of a parameter indicating the logic specification of the portion; and a position of the parameter on the first stream.

8. A stream recording/reproducing apparatus that records a first stream onto a first recording medium and then dubs the first stream onto a second recording medium, said apparatus comprising:
a judgment unit operable to judge whether or not the first stream is compliant with a logic specification of the second recording medium;
a conversion unit operable to convert the first stream into a second stream that is compliant with the logic specification of the second recording medium;
a first recording unit operable to record the second stream onto the first recording medium in the case where said judgment unit judges that the first stream is not compliant with the logic specification of the second recording medium; and
a second recording unit operable to record the second stream recorded on the first recording medium onto the second recording medium.

9. The stream recording/reproducing apparatus according to claim 8,
wherein said conversion unit is operable to decode the first stream, and to encode a signal obtained by the decoding into the second stream that is compliant with the logic specification of the second recording medium.

10. The stream recording/reproducing apparatus according to claim 8,
wherein the first stream includes a video elementary stream and an audio elementary stream, and
said conversion unit is operable to store data into User_data in a Group of Picture layer, the data being the same as subtitle data included in User_data in a Picture layer of the video elementary stream.

11. The stream recording/reproducing apparatus according to claim 8,
wherein said judgment unit is operable to judge whether or not the first stream is compliant with the logic specification of the second recording medium before said first recording unit starts the recording.

12. A stream recording/reproducing apparatus that records a first stream onto a first recording medium and then dubs the first stream onto a second recording medium, said apparatus comprising:
a judgment unit operable to judge whether or not the first stream is compliant with a logic specification of the second recording medium;
a conversion unit operable to convert the first stream into a second stream that is compliant with the logic specification of the second recording medium;
a first recording unit operable to record the first stream and the second stream onto the first recording medium;
a deletion unit operable (i) to delete the first stream recorded on the first recording medium in the case where said judgment unit judges that a portion constituting the first stream is not compliant with the logic specification of the second recording medium, and (ii) to delete the second stream recorded on the first recording medium in the case where said judgment unit judges that all portions constituting the first stream are compliant with the logic specification of the second recording medium; and
a second recording unit operable to record the stream remaining on the first recording medium onto the second recording medium.

13. The stream recording/reproducing apparatus according to claim 12,
wherein said conversion unit is operable to decode the first stream, and to encode a signal obtained by the decoding into the second stream that is compliant with the logic specification of the second recording medium.

14. A stream recording/reproducing method for recording a first stream onto a first recording medium and then dubbing the first stream onto a second recording medium, said method comprising:
judging whether or not the first stream is compliant with a logic specification of the second recording medium;
recording the first stream onto the first recording medium;
recording a result of the judgment obtained by said judging onto the first recording medium;
converting the first stream recorded on the first recording medium into a second stream that is compliant with the logic specification of the second recording medium in the case where the result of the judgment recorded on the first recording medium indicates that the first stream is not compliant with the logic specification of the second recording medium; and
recording the second stream onto the second recording medium.

15. A stream recording/reproducing method for recording a first stream onto a first recording medium and then dubbing the first stream onto a second recording medium, said method comprising:
judging whether or not the first stream is compliant with a logic specification of the second recording medium;
converting the first stream into a second stream that is compliant with the logic specification of the second recording medium;
recording the second stream onto the first recording medium in the case where the judgment in said judging is that the first stream is not compliant with the logic specification of the second recording medium; and
recording the second stream recorded on the first recording medium onto the second recording medium.

16. A stream recording/reproducing method for recording a first stream onto a first recording medium and then dubbing the first stream onto a second recording medium, said method comprising:
judging whether or not the first stream is compliant with a logic specification of the second recording medium;
converting the first stream into a second stream that is compliant with the logic specification of the second recording medium;
recording the first stream and the second stream onto the first recording medium;
(i) deleting the first stream recorded on the first recording medium in the case where the judgment in said judging is that a portion constituting the first stream is not compliant with the logic specification of the second recording medium, and (ii) deleting the second stream recorded on the first recording medium in the case where the judgment in said judging is that all portions constituting the first stream are compliant with the logic specification of the second recording medium; and
recording the stream remaining on the first recording medium onto the second recording medium.

17. An integrated circuit for recording a first stream onto a first recording medium and then dubbing the first stream onto a second recording medium, said integrated circuit comprising:
a judgment unit operable to judge whether or not the first stream is compliant with a logic specification of the second recording medium;
a first stream recording unit operable to record the first stream onto the first recording medium;
a judgment result recording unit operable to record a result of the judgment obtained by said judgment unit onto the first recording medium;
a conversion unit operable to convert the first stream recorded on the first recording medium into a second stream that is compliant with the logic specification of the second recording medium in the case where the result of the judgment recorded on the first recording medium indicates that the first stream is not compliant with the logic specification of the second recording medium; and
a second stream recording unit operable to record the second stream onto the second recording medium.

18. An integrated circuit for recording a first stream onto a first recording medium and then dubbing the first stream onto a second recording medium, said integrated circuit comprising:
a judgment unit operable to judge whether or not the first stream is compliant with a logic specification of the second recording medium;
a conversion unit operable to convert the first stream into a second stream that is compliant with the logic specification of the second recording medium;
a first recording unit operable to record the second stream onto the first recording medium in the case where said judgment unit judges that the first stream is not compliant with the logic specification of the second recording medium; and
a second recording unit operable to record the second stream recorded on the first recording medium onto the second recording medium.

19. An integrated circuit for recording a first stream onto a first recording medium and then dubbing the first stream onto a second recording medium, said integrated circuit comprising:
a judgment unit operable to judge whether or not the first stream is compliant with a logic specification of the second recording medium;
a conversion unit operable to convert the first stream into a second stream that is compliant with the logic specification of the second recording medium;
a first recording unit operable to record the first stream and the second stream onto the first recording medium;
a deletion unit operable (i) to delete the first stream recorded on the first recording medium in the case where said judgment unit judges that a portion constituting the first stream is not compliant with the logic specification of the second recording medium, and (ii) to delete the second stream recorded on the first recording medium in the case where said judgment unit judges that all portions constituting the first stream are compliant with the logic specification of the second recording medium; and
a second recording unit operable to record the stream remaining on the first recording medium onto the second recording medium.
